(19) United States
(12) Patent Application Publication
(10) Pub. No.: US 2026/0023254 A1
(43) Pub. Date: Jan. 22, 2026

(54) Methods, Systems, and Devices for Inverted Microscope Guides

(71) Applicant: IDEXX Laboratories, Inc., Westbrook, ME (US)

(72) Inventors: Michael Nesci, Brampton (CA); James Park, Bowmanville (CA); Mallory Howren, North Charleston, SC (US); Erika Davis, Jacksonville, FL (US); Stephanie Oslund, Greenville, SC (US)

(21) Appl. No.: 19/270,833

(22) Filed: Jul. 16, 2025

Related U.S. Application Data
(60) Provisional application No. 63/672,057, filed on Jul. 16, 2024.

(51) Int. Cl. G02B 21/24

(52) U.S. Cl. CPC G02B 21/24

(57) ABSTRACT

A guide device for visually isolating and/or annotating one or more wells of a well plate is disclosed. The guide device includes a first segment including first dimensions to cover a first portion of a first row of wells of the well plate. The guide device also includes a second segment including second dimensions to cover a first portion of a second row of wells of the well plate. The guide device also includes a well cover. The well cover interfaces with the first and second segments. The well cover includes an opening to visually isolate at least one well in a selected row of wells of the well plate disposed between the first row of wells and the second row of wells. In another embodiment, the guide device includes a well plate cover for annotating wells.

### RELATED APPLICATIONS

This application claims priority to U.S. Provisional Application No. 63/672,057 filed Jul. 16, 2024 which is incorporated herein by reference in its entirety.

### FIELD OF THE DISCLOSURE

The present disclosure involves devices, systems, and methods for guide device for visually isolating and/or annotating one or more wells of a well plate. Namely, devices, systems, and methods of the disclosure utilize an inverted microscope guide device to visually isolate and/or annotate a single well of the well plate. In examples, the inverted microscope guide device includes a perimeter that exposes a row within the well plate and a well cover that focuses on a single well within the row. In other examples, the inverted microscope guide device includes an opaque well plate cover with a plurality of openings for a plurality of wells in a well plate and a plurality of well indicators in an illumination zone associated with each of a plurality of wells.

### BACKGROUND

Biological samples can be organized utilizing a variety of different methods, including utilizing a well plate.

### SUMMARY

Technicians typically use well plates to organize different biological samples, such as urine and blood, for analysis. In some embodiments, a well plate includes multiple rows and columns of wells in which biological samples are inserted for analysis. In examples, technicians may identify any particular well within the well plate using a corresponding row and column identifier. One common technique for analyzing the biological samples is using an inverted microscope.

In fast-paced laboratory settings, it can be relatively difficult to navigate through a well plate full of biological samples while using an inverted microscope. For example, fatigue and human error may result in a technician mixing up different biological samples on the well plate during analysis, particularly as they move from well to well in the well plate. For example, because there are multiple rows and columns of wells, it may be relatively easy for a technician to confuse one well with another. As a result, when the technician generates a report based on the analysis of the wells on the well plate, the report may contain errors and need to be corrected and may require additional testing and/or analysis, among other issues.

Further, in laboratory settings, it is integral that these reports are timely and accurate. Every report that contains a mix up may potentially result in a misdiagnosis, which may result in a multitude of errors, unwanted costs, and wasted time. For example, if the contents of a particular well are mixed up with another well, a healthy patient may be misdiagnosed as unhealthy and/or an unhealthy patient may be misdiagnosed as healthy, and so on. Thus, there exists a need for consistent, timely, and accurate analytical techniques for reading wells in a well plate, particularly with an inverted microscope.

The techniques described herein introduce an inverted microscope guide device that reduces human error when analyzing different biological samples in one or more wells of a well plate. In examples, the guide device described herein limits the field of view into one or more specific rows and one or more specific column or annotates the well being viewed. As a result, when a technician is moving between and analyzing multiple wells and analyzing the contents therein, a more consistent, efficient, and accurate reading for each well is accomplished, as is a clear confirmation as to which well is being analyzed.

In example embodiments, a guide device is described herein that visually isolates and annotates one or more wells of a well plate, all without any modification to the well plate itself and/or the biological samples therein. In examples, the guide device includes a first segment including first dimensions to cover a first portion of a first row of wells of the well plate. In examples, the guide device also includes a second segment including second dimensions to cover a first portion of a second row of wells of the well plate. In examples, the guide device also includes a well cover. The well cover interfaces with the first and second segments. In examples, the well cover includes an opening to visually isolate at least one well in a selected row of wells of the well plate disposed between the first row of wells and the second row of wells.

In another example embodiment, a guide device for visually annotating one or more wells of a well plate comprises an opaque well plate cover having vertical and horizontal dimensions coordinating to vertical and horizontal dimensions of the well plate and having a plurality of openings in a vertical and horizontal array configured to line up with the wells in the well plate wherein the well plate cover has one or more visual well indicators on the opaque well plate, in a space between wells, in an illumination zone for a well associated with that visual well indicator.

In another example, a method of fabricating a guide device that is usable to visually isolate one or more wells of a well plate is described. In examples, the method includes fabricating an outer perimeter having a first segment and a second segment. In examples, the first segment comprises first dimensions to cover a first portion of a first row of wells of the well plate. In examples, the second segment comprises second dimensions to cover a first portion of a second row of wells of the well plate. In examples, the method also include fabricating a well cover. In examples, the well cover interfaces with the first and second segments. In examples, the well cover includes an opening to visually isolate at least one well in a selected row of wells of the well plate disposed between the first row of wells and the second row of wells.

In another example, a non-transitory computer-readable medium is described, having instructions stored thereon, wherein the instructions, when executed by one or more processors of a computing device (e.g., a three-dimensional (3D) printer), cause the computing to perform a set of operations. In examples, the set of operations comprises fabricating an outer perimeter of a guide device having a first segment and a second segment. In examples, the first segment comprises first dimensions to cover a first portion of a first row of wells of the well plate. In examples, the second segment comprises second dimensions to cover a first portion of a second row of wells of the well plate. In examples, the set of operations also includes fabricating a well cover of the guide device. In examples, the well cover interfaces with the first and second segments. In examples, the well cover includes an opening to visually isolate at least one well in a selected row of wells of the well plate disposed between the first row of wells and the second row of wells.

In another example, a method of visually isolating one or more wells of a well plate is described. In examples, the method includes positioning an outer perimeter of a guide device. In examples, the outer perimeter has a first segment comprising first dimensions to cover a first portion of a first row of wells of the well plate. In examples, the outer perimeter has a second segment comprising second dimensions to cover a first portion of a second row of wells of the well plate. In examples, the method also includes positioning a well cover of the guide device. In examples, the well cover comprises an opening to visually isolate at least one well in a selected row of wells of the well plate disposed between the first row of wells and the second row of wells.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1A illustrates a diagram of a guide device that is configured to visually isolate one or more wells of a well plate, according to an example embodiment.

FIG. 1B illustrates a diagram of a well plate cover attached to a well plate to visually identify one or more wells of the well plate, according to another example embodiment.

FIG. 1C illustrates a photograph of the well plate cover attached to a well plate to visually identify one or more wells of the well plate with light from a microscope, according to another example embodiment.

FIG. 2 illustrates a diagram of the guide device attached to a well plate to visually isolate one or more wells of the well plate, according to an example embodiment.

FIG. 3 illustrates a back view of different components of the guide device that is configured to visually isolate one or more wells of a well plate, according to an example embodiment.

FIG. 4 illustrates a front view of different components of the guide device that is configured to visually isolate one or more wells of a well plate, according to an example embodiment.

FIG. 5 illustrates an example inverted microscope, according to an example embodiment.

FIG. 6 illustrates a simplified block diagram of an example computing device, according to an example embodiment.

FIG. 7 illustrates a method, according to an example embodiment.

FIG. 8 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers may refer to the same or similar elements or components throughout.

Within examples, the disclosure is directed to devices, systems, and methods for visually isolating and/or annotating one or more wells of a well plate.

In an example embodiment, an inverted microscope guide device, herein referred to as a “guide device”, reduces human error when analyzing different biological samples in wells of the well plate. In examples, the guide device includes an outer perimeter that is rectangular in shape. For example, the guide device includes top segment, a left segment, a bottom segment, and a right segment. In examples, the different segments of the outer perimeter define a row window that visually exposes a selected row of wells of the well plate. In examples, the dimensions (e.g., the length and width) of the segments cover rows that are adjacent to (e.g., above and below) the selected row. In examples, the outer perimeter of the guide device can move vertically along the well plate such that different rows are exposed by row window as the outer perimeter of the guide device is moved.

In examples, the well cover interfaces with the top and bottom segments of the outer perimeter. The well cover includes an opening that has dimensions to expose a single well within the selected row of wells. In examples, the well cover is configured to move laterally (e.g., horizontally) along the row window to expose different wells with the selected row of wells via the opening.

Thus, in examples, the guide device disclosed herein enables a technician to visually isolate a particular well on the well plate that is being analyzed to reduce confusion. By moving the outer perimeter vertically along the well plate, the guide device can highlight (e.g., visually isolate) different rows of wells of the well plate via the row window. Additionally, by moving the well plate horizontally along the row window, a particular well within the selected row can be visually isolated from the other wells in the selected row.

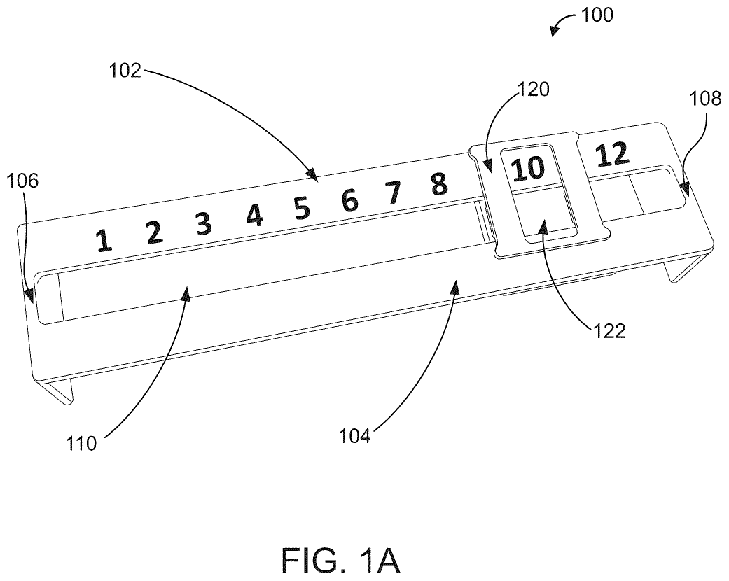

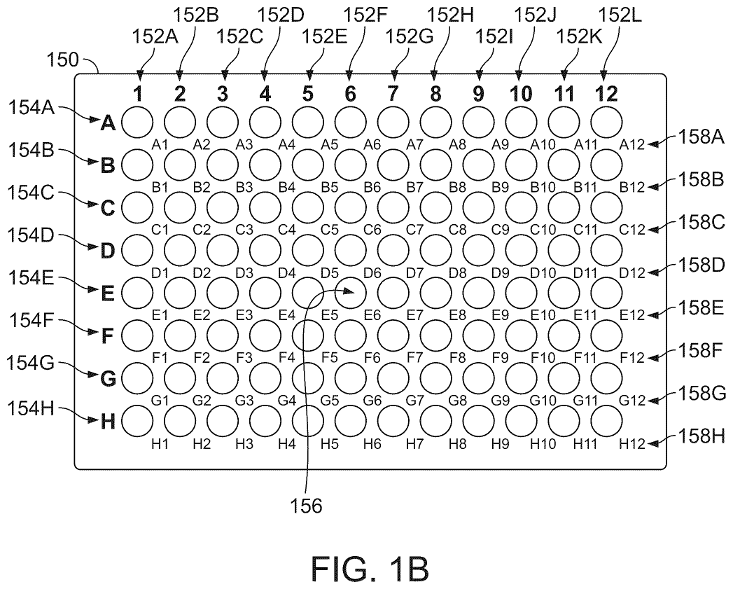

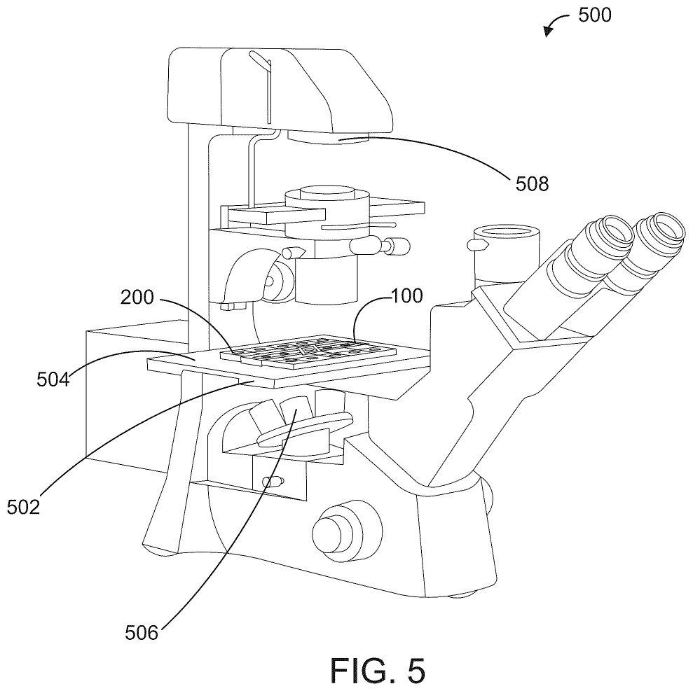

Referring now to the figures, FIG. 1A is a diagram of a guide device 100 that is configured to visually isolate one or more wells of a well plate, according to an example embodiment. In particular, the guide device 100 may correspond to an inverted microscope guide device that is used to visually isolate a selected well in a well plate placed on an inverted microscope, such as the inverted microscope 500 of FIG. 5.

In examples, the guide device 100 includes a first segment 102, a second segment 104, a first side segment 106, and a second side segment 108. In examples, the first segment 102 may correspond to an upper segment of the guide device 100, and the second segment 104 may correspond to a lower segment of the guide device 100. In examples, the first side segment 106 may correspond to a left side segment of the guide device 100, and the second side segment 108 may correspond to a right side segment of the guide device 100. In examples, the first side segment 106 connects a first end of the first segment 102 to a first end of the second segment 104, and the second side segment 108 connects a second end of the first segment 102 to a second end of the second segment 104.

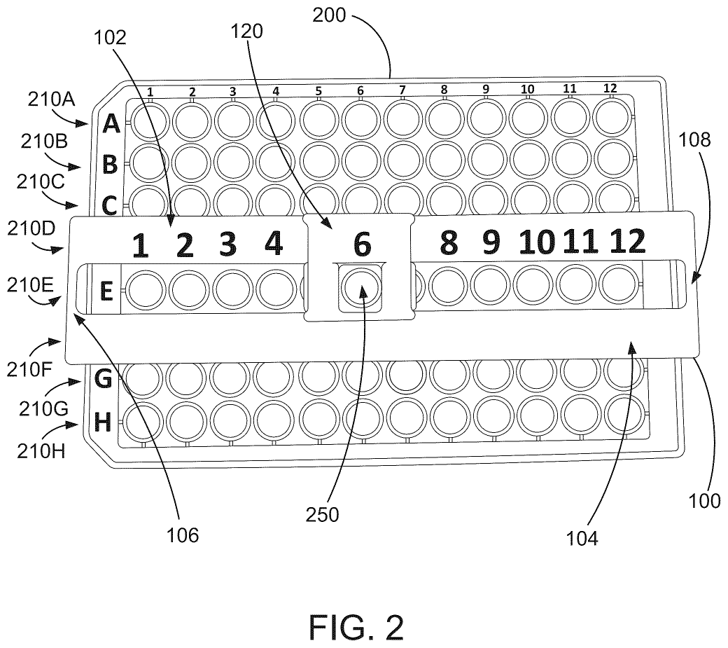

In examples, the row window 110 of the guide device 100 is defined by the first segment 102, the second segment 104, the first side segment 106, and the second side segment 108. As described with respect to FIG. 2, the row window 110 can be used to highlight and/or otherwise annotate (e.g., visually isolate) a selected row of wells in well plate.

In examples, the first segment 102 may include first dimensions to cover a first portion of a first row of wells of the well plate, as illustrated and described in greater detail with respect to FIG. 2. For example, a height and width of the first segment 102 may cover at least a portion of a row of wells of the well plate. In some embodiments, the first dimensions of the first segment 102 enables the first segment 102 to fully cover the first row of wells. In examples, the second segment 104 may include second dimensions to cover a first portion of a second row of wells of the well plate, as illustrated and described in greater detail with respect to FIG. 2. For example, a height and width of the second segment 104 may cover at least a portion of another row of wells of the well plate. In some embodiments, the second dimensions of the second segment 104 enables the second segment 104 to fully cover the second row of wells.

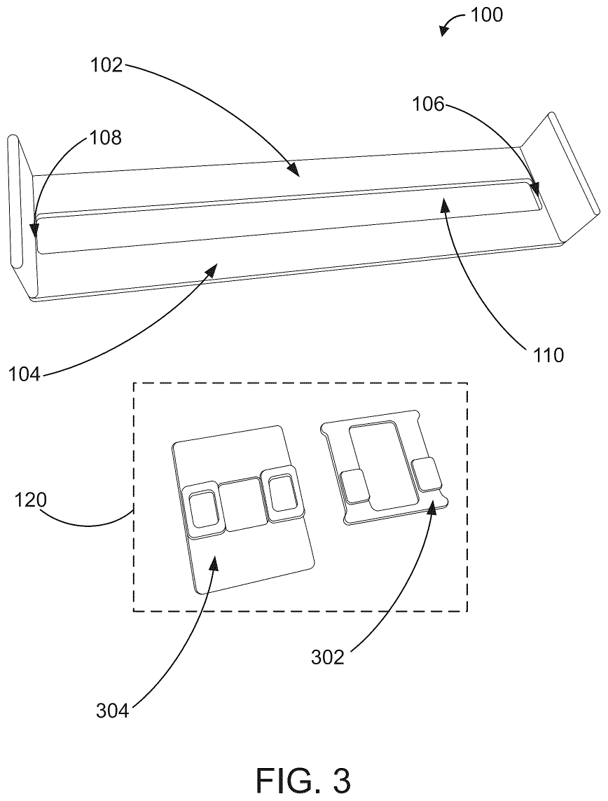

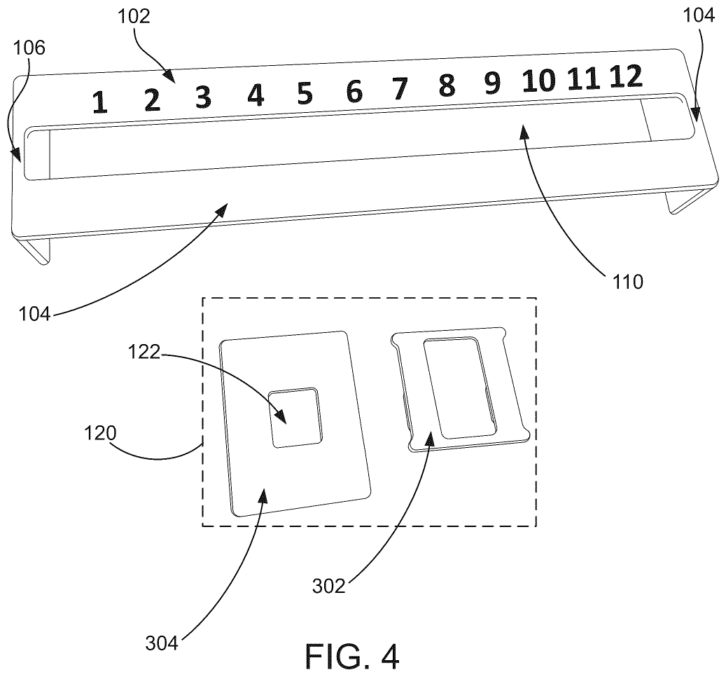

In examples, the guide device 100 also includes a well cover 120 that interfaces with the first segment 102 and the second segment 104. For example, the well cover 120 is attached to the first segment 102 and the second segment 104. As described in greater detail with respect to FIGS. 3 and 4, in examples, the well cover 120 includes (i) a first component configured to slide under the first segment 102 and the second segment 104 and (ii) a second component that is attached to the first component. In examples, the second component is configured to slide over the first segment 102 and the second segment 104.

In examples, the well cover 120 includes an opening 122 to visually isolate at least one well in a selected row of wells of the well plate, as illustrated and described in greater detail with respect to FIG. 2. In some scenarios, the opening 122 visually isolates a single well in the selected row of wells. In examples, the first segment 102 may include one or more visual indicators to identify the at least one well visually isolated by the opening 122 of the well cover 120. For example, as depicted in FIG. 1A, the first segment 102 includes numerical indicators (e.g., “1”, “2”, “3”, “4”, “5”, “6”, “7”, “8”, “9”, “10”, “11”, and “12”) that are used to identify a well isolated by the opening 122. In examples, as illustrated in FIG. 1A, the well proximate to numerical indicator “10” would be visually isolated from other wells highlighted by the row window 110. Other examples are possible.

In examples, the first segment 102, the second segment 104, the first side segment 106, and the second side segment 108 may be comprised of at least one of a plastic material, a rubber material, a paper material, a compostable material or a metal material. Similarly, in examples, the well cover 120 may be comprised of at least one of a plastic material, rubber material, a paper material, a compostable material or a metal material. Other examples are possible.

In examples, the guide device 100 of FIG. 1A may be used to reduce human error when analyzing different biological samples in wells of a well plate. For example, the guide device 100 may limit the field of view into a specific row and a specific column. As a result, when a technician is going back and forth between wells and analyzing the contents, there is no confusion as to which well is being analyzed.

Referring now to the figures, FIG. 1B is a diagram of another guide device 150 that is configured to visually identify one or more wells of a well plate, according to an example embodiment. In particular, the guide device 150 may correspond to an inverted microscope guide device that is used to visually identify a selected well in a well plate placed on an inverted microscope, such as the inverted microscope 500 of FIG. 5.

In examples, the guide device 150 is a well plate cover 150 that sits on top of or removably attaches to a well plate having a horizontal dimension 152 and a vertical dimension 154 and a plurality of opening 156 to allow for viewing of a plurality of wells on a well plate beneath.

In examples, the well plate cover includes one or more horizontal visual indicators 152A-L and one or more vertical indicators 154A-H. One or more well indictors 158 are also included in the space between wells on the well plate cover 150 near each of the plurality of openings 156.

The one or more visual indicators identify the at least one well beneath the plurality of openings. For example, as depicted in FIG. 1B, the horizonal dimension 152 includes a first type of indicator 152A-L, e.g. numerical indicators (e.g., “1”, “2”, “3”, “4”, “5”, “6”, “7”, “8”, “9”, “10”, “11”, and “12”) that are used to identify a horizontal well position. The vertical dimension 154 includes a second type of indicator 154A-H, e.g. alphabetical indicators (e.g., “A”, “B”, “C”, “D”, “E”, “F”, “G”, “H”) that are used to identify a vertical well position. The space between wells on the well plate cover 150 near each of the plurality of openings 156 includes a well indicator 158, e.g. an alphanumeric indictor from combining the vertical and horizontal visual indicators (e.g. “A1”, “B2”, “C3”, “E4”, “F5”, “G6”, “H7”, etc.) that are used to identify the overall well position.

In examples, the well plate cover 150 may be comprised of at least one of a plastic material, a rubber material, a paper material, a compostable material or a metal material. Other examples are possible.

In a further aspect, if one or more materials of the guide device 150 are constructed from one or more opaque and/or semi-opaque materials, then the assembled guide device 150 may create an aperture that isolates one or more wells in a selected well in the well plate (e.g., by focusing the user's attention and view of the well, the objective lens' focus on the well, as well as any lighting that may other color or detract from the well itself, potentially via backlighting and/or side lighting). Other examples are possible.

It should be understood that the configuration of the well plate cover 150 is for illustrative purposes only and is not construed to be limiting. In other embodiments, the well plate cover 150 can include additional or fewer rows depending on the well plate it is designed to be used with. As a non-limiting example, in some embodiments, the well plate cover 150 can include ten (10) rows. As another non-limiting example, in some embodiments, the well plate cover 150 can include five (5) rows. Additionally, in other embodiments, each row of the well plate cover 150 can include a different number of openings.

FIG. 1C illustrates a photograph of a well plate cover 150 attached to a well plate to visually identify one or more wells of the well plate with light from a microscope. The well in horizontal position “4” and vertical position “A” is illuminated by a microscope during viewing by a user. The well indictor “A4” on the well plate cover 150 in the space near the opening over the illuminated well indicates the horizontal position “4” and the vertical position “A” of that well. The well indicators, e.g. “A4”, are positioned near the opening on the well plate cover such that they are in an illumination zone, i.e. the area that is illuminated by the microscope during the viewing of that well, and easily viewed during reading of that particular well, i.e. the well at the “A4” position.

In examples, the guide device 150 of FIG. 1B may be used to reduce human error when analyzing different biological samples in wells of a well plate. For example, the guide device 150 may clearly identify the well being viewed by including a well indicator in an area near the well that is illuminated by the microscope. As a result, when a technician is going back and forth between wells and analyzing the contents, there is no confusion as to which well is being analyzed.

FIG. 2 illustrates a diagram of a guide device attached to a well plate to visually isolate and/or annotate one or more wells of the well plate, according to an example embodiment. In particular, in examples, the guide device 100 of FIG. 1A may be attached to a well plate 200 to visually isolate a particular well 250 of the well plate 200.

The well plate 200 includes a plurality of rows 210. For example, as depicted in FIG. 2, the well plate 200 includes a row 210A (designated as row “A”), a row 210B (designated as row “B”), a row 210C (designated as row “C”), a row 210D (designated as row “D”), a row 210E (designated as row “E”), a row 210F (designated as row “F”), a row 210G (designated as row “G”), and a row 210H (designated as row “H”). Each row 210 includes a plurality of wells. As depicted in FIG. 2, each row 210 includes twelve (12) wells, denoted by the numerical indicators at the top of the well plate 200.

It should be understood that the configuration of the well plate 200 is for illustrative purposes only and is not construed to be limiting. In other embodiments, the well plate 200 can include additional or fewer rows 210. As a non-limiting example, in some embodiments, the well plate 200 can include ten (10) rows 210. As another non-limiting example, in some embodiments, the well plate 200 can include five (5) rows. Additionally, in other embodiments, each row 210 of the well plate 200 can include a different number of wells.

In examples, the outer perimeter of the guide device 100 (e.g., the rectangular portion comprised of the first segment 102, the second segment 104, the first side segment 106, and the second side segment 108) may be configured to move slide along the well plate 200 in a vertical manner. For example, the first side segment 106 of the guide device 100 may be configured to slide along a first edge (e.g., a left edge) of the well plate 200, and the second side segment 108 of the guide device 100 may be configured to slide along a second edge (e.g., a right edge) of the well plate 200. In examples, as the guide device 100 slides along the well plate 200 in the vertical manner, the row window 110 of the guide device 100 highlights (e.g., visually isolates) different rows 210. Other examples are possible. In examples, a coefficient of friction between the well plate 200 and the outer perimeter of the guide device 100 may be below a threshold value to more easily enable the guide device 100 to slide along the well plate 200. As a result, in example embodiments, it may be relatively easy to move (e.g., slide) the guide device 100 to different positions along the well plate 200.

As depicted in FIG. 2, in examples, the guide device 100 is in a position such that the row window 110 of the guide device 100 visually isolates the row 210E (e.g., the selected row) of the wells. In examples, to visually isolate the selected row 210E, the first dimensions of the first segment 102 of the guide device 100 cover the row 210D above the selected row 210E of wells, and the second dimensions of the second segment 104 of the guide device 100 cover the row 210F below the selected row 210E of wells.

In examples, the well cover 120 of the guide device 100 is configured to slide along horizontally along the row window 110 to visually isolate at least one well in the selected row 210E of wells. As depicted in FIG. 2, the position of the well cover 120 enables the well cover 120 to visually isolate the well 250 in the selected row 210E of wells. For example, the opening 122 of the well cover 120 visually isolates the well 250 in the selected row 210E of wells disposed between the row 210D of wells and the row 210F of wells.

In examples, the techniques described with respect to FIG. 2 may be used to reduce human error when analyzing different biological samples in wells of the well plate 200. For example, the guide device 100 limits the field of view into a specific row and a specific column. As a result, when a technician is going back and forth between wells and analyzing the contents, there is no confusion as to which well is being analyzed.

In a further aspect, if one or more materials of the guide device are constructed from one or more opaque and/or semi-opaque materials, then the assembled guide device 100 may create an aperture that isolates one or more wells in a selected well in the well plate (e.g., by focusing the user's attention and view of the well, the objective lens' focus on the well, as well as any lighting that may other color or detract from the well itself, potentially via backlighting and/or side lighting). Other examples are possible.

FIG. 3 illustrates a back view of different components of the guide device 100 that is configured to visually isolate one or more wells of a well plate, according to an example embodiment. In particular, in examples, the diagram of FIG. 3 depicts (i) a back view of the outer ring (e.g., the first segment 102, the second segment 104, the first side segment 106, and the second side segment 108) of the guide device 100 and (ii) a back view of components of the well cover 120.

In examples, the well cover 120 includes a first component 302 configured to slide under the first segment 102 of the guide device 100 and the second segment 104 of the guide device 100. In examples, the well cover 120 also includes a second component 304 that is attachable to the first component 302. For example, the second component 304 may snap (e.g., couple) into the first component 302. In examples, the second component 304 is configured to slide over the first segment 102 of the guide device 100 and the second segment 104 of the guide device 100.

FIG. 4 illustrates a front view of different components of the guide device 100 that is configured to visually isolate one or more wells of a well plate, according to an example embodiment. In particular, in examples, the diagram of FIG. 4 depicts (i) a front view of the outer ring (e.g., the first segment 102, the second segment 104, the first side segment 106, and the second side segment 108) of the guide device 100 and (ii) a front view of components of the well cover 120.

In examples, the well cover 120 includes a first component 302 configured to slide under the first segment 102 of the guide device 100 and the second segment 104 of the guide device 100. In examples, the well cover 120 also includes a second component 304 that is attachable to the first component 302. For example, the second component 304 may snap (e.g., couple) into the first component 302. In examples, the second component 304 is configured to slide over the first segment 102 of the guide device 100 and the second segment 104 of the guide device 100.

In examples, the guide device 100 in FIGS. 3 and 4 may be used to reduce human error when analyzing different biological samples in wells of a well plate. For example, the guide device 100 limits the field of view into a specific row and a specific column. As a result, when a technician is going back and forth between wells and analyzing the contents, there is no confusion as to which well is being analyzed.

Now referring to FIG. 5, the guide device 100 and the well plate 200 of FIGS. 1-4 are shown in connection with an example inverted microscope 500 is disclosed, which includes a platform 502, a well plate receiving area 504, an objective lens 506, and a brightfield light source 508 opposite from the objective lens 506, according to an example embodiment. In examples, the platform 502 includes the well plate receiving area 504, and in some embodiments, the well plate receiving area 504 is configured to receive the well plate 200, as illustrated in FIG. 5. In examples, the guide device 100 can be inserted on the well plate 200 to visually isolate one or more wells of the well plate 200, as described above. In examples, the brightfield light source 508 shines light through the well plate receiving area 504, allowing a user to observe samples placed of the well plate receiving area 504 via the objective lens 506. In some examples, a plurality of sensors may be coupled to the objective lens 506, according to example embodiments. Other examples are possible.

As depicted in the example embodiment of FIG. 5, the illustrated example dimensions (e.g., height, width, thickness, etc.) of the guide device 100 enables the guide device 100 to fit securely on the inverted microscope 500, all without interfering with any portions of the inverted microscope 500 (e.g., objective lens 506, brightfield light source 508, etc.) and/or the well plate 200. For example, the height of the guide device 100 is small enough to enable a user to maneuver (e.g., slide) the guide device 100 along the well plate 200 without contacting and/or interfering with one or more portions of the inverted microscope 500.

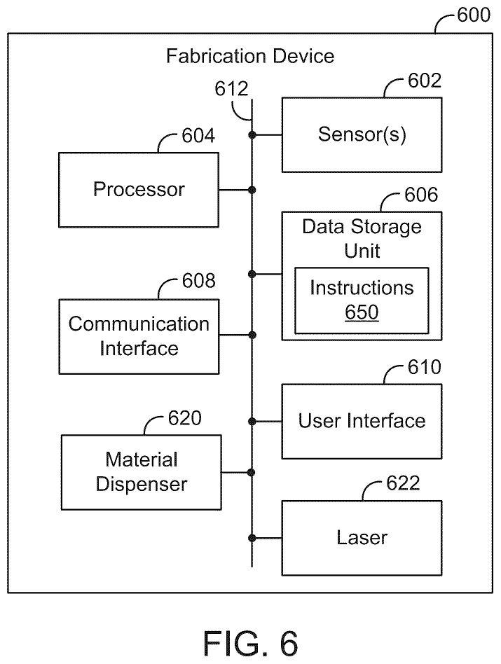

Turning to FIG. 6, FIG. 6 illustrates a simplified block diagram of an example computing device 600 (e.g., a fabrication device) of a system. In examples, the computing device 600 can fabricate the guide device 100 or well plate cover 150 described in this disclosure. In examples, the computing device 600 can include various components, such as sensors 602, a processor 604, a data storage unit 606, a communication interface 608, a user interface 610, a material dispenser 620, and/or a laser 622. In examples, these components can be connected to each other (or to another device, system, or other entity) via connection mechanism 612.

In examples, the sensor 602 can include sensors now known or later developed, including but not limited to an imaging sensor, which may include one or more of a camera, a thermal imager, photodiode sensors, a proximity sensor (e.g., a sensor and/or communication protocol to determine the proximity of a slide of a microscopy analyzer to an objective lens) and/or a combination of these sensors, among other possibilities. In examples, these sensors may also include zoom lenses, monochromatic sensors, color sensors, digital sensors, electromagnetic sensors, and/or a combination of these, among other possibilities.

In examples, the processor 604 can include a general-purpose processor (e.g., a microprocessor) and/or a special-purpose processor (e.g., a digital signal processor (DSP)).

In examples, the data storage unit 606 can include one or more volatile, non-volatile, removable, and/or non-removable storage components, such as magnetic, optical, or flash storage, and/or can be integrated in whole or in part with processor 604. In examples, the data storage unit 606 can take the form of a non-transitory computer-readable storage medium, having stored thereon instructions 650 (e.g., compiled or non-compiled program logic and/or machine code) that, when executed by processor 604, cause computing device 600 to perform fabricate the guide device 100. As such, in examples, the computing device 600 can be configured to dispense material layers to fabricate/create the guide device 100 with the material dispenser 620 and shape (e.g., cut or print out) the guide device 100 using the laser 622. Thus, in some implementations, the computing device 600 may correspond to a 3D printer.

In some instances, the computing device 600 can execute program instructions in response to receiving an input, such as from communication interface 608 and/or user interface 610.

In examples, the communication interface 608 can allow computing device 600 to connect to and/or communicate with another other entity according to one or more protocols. In one example, the communication interface 608 can be a wired interface, such as an Ethernet interface or a high-definition serial-digital-interface (HD-SDI). In another example, the communication interface 608 can be a wireless interface, such as a cellular or WI FI interface. In this disclosure, a connection can be a direct connection or an indirect connection, the latter being a connection that passes through and/or traverses one or more entities, such as a router, switch, or other network device. Likewise, in this disclosure, a transmission can be a direct transmission or an indirect transmission.

In examples, the user interface 610 can facilitate interaction between computing device 600 and a user of computing device 600, if applicable. As such, in examples, the user interface 610 can include input components such as a keyboard, a keypad, a mouse, a touch sensitive panel, a microphone, a camera, and/or a movement sensor, all of which can be used to obtain data indicative of an environment of computing device 600, and/or output components such as a display device (which, for example, can be combined with a touch sensitive panel), a sound speaker, and/or a haptic feedback system. More generally, in examples, the user interface 610 can include hardware and/or software components that facilitate interaction between computing device 600 and the user of the computing device 600.

In examples, the computing device 600 can take various forms, such as a 3D printer, an automatic injection molder, a computer numerical control machine, a four-dimensional (4D) printer, etc.

### Example Methods and Aspects

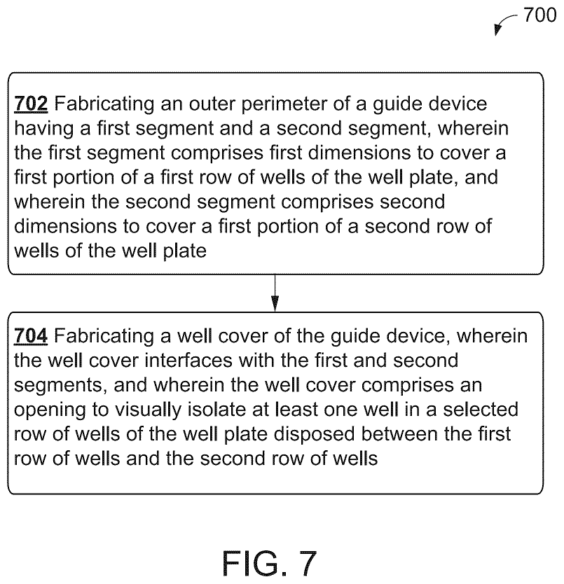

Now referring to FIG. 7, an example method 700 of fabricating a guide device is disclosed. The method 700 shown in FIG. 7 presents an example of a method that could be used with the components shown in FIGS. 1-6, for example. Further, devices or systems may be used or configured to perform logical functions presented in FIG. 7. In other examples, components of the devices and/or systems may be arranged to be adapted to, capable of, or suited for performing the functions, such as when operated in a specific manner. In examples, the method 700 may include one or more operations, functions, or actions as illustrated by one or more of blocks 702-706. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 702, in examples, the method 700 for fabricating the guide device includes fabricating an outer perimeter having a first segment and a second segment. In some examples, the first segment comprises first dimensions to cover a first portion of a first row of wells in a well plate. In some examples, the second segment comprises second dimensions to cover at first portion of a second row of wells of the well plate.

At block 704, in examples, the method 700 includes fabricating a well cover. In some examples, the well cover interfaces with the first and second segments, and the well cover comprises an opening to visually isolate at least one well in a selected row of wells of the well plate disposed between the first row of wells and the second row of wells. In some examples, the at least one well in the selected row of wells comprises a single well. In some examples, the well cover does not cover at least one well in the selected row of wells.

In some examples, the outer perimeter and the well cover are fabricated using one or more three-dimensional (3D) printing operations.

In some examples, the well cover is attached to the first segment and the second segment. In some examples, the well cover comprises (i) a first component configured to slide under the first segment and the second segment and (ii) a second component attachable to the first component. The second component may be configured to slide over the first segment and the second segment.

In some examples of the method 700, the outer perimeter comprises a first side segment connecting a first end of the first segment to a first end of the second segment. In some examples of the method 700, the outer perimeter comprises a second side segment connecting a second end of the first segment to a second end of the second segment. A row window of the guide device may be defined by the first segment, the second segment, the first side segment, and the second side segment. In some examples, the first side segment corresponds to a left side segment of the guide device, and the second side segment corresponds to a right side segment of the guide device. In some examples, the first side segment is configured to slide along a first edge of the well plate, and the second side segment is configured to slide along a second edge of the well plate. In some examples, the first segment includes one or more visual indicators to identify the at least one well visually isolated by the opening of the well cover.

In some examples, at least one of the first segment and the second segment comprise at least one of: (i) a plastic material; (ii) a rubber material; (iii) a paper material, (iv) a compostable material or (v) a metal material. In some examples, the well cover comprises at least one of: (i) a plastic material; (ii) a rubber material; (iii) a paper material, (iv) a compostable material or (v) a metal material.

In one aspect, a non-transitory computer-readable medium, having stored thereon program instructions that, when executed by one or more processors of a computing device (e.g., a fabrication device), cause the computing device to perform operations, the operations including fabricating a first segment of a guide device, wherein the first segment comprises first dimensions to cover a first portion of a first row of wells in a well plate, fabricating a second segment of the guide device, wherein the second segment comprises second dimensions to cover a first portion of a second row of wells of the well plate, and fabricating a well cover of the guide device. In examples, the well cover interfaces with the first and second segments, and the well cover comprises an opening to visually isolate at least one well in a selected row of wells of the well plate disposed between the first row of wells and the second row of wells.

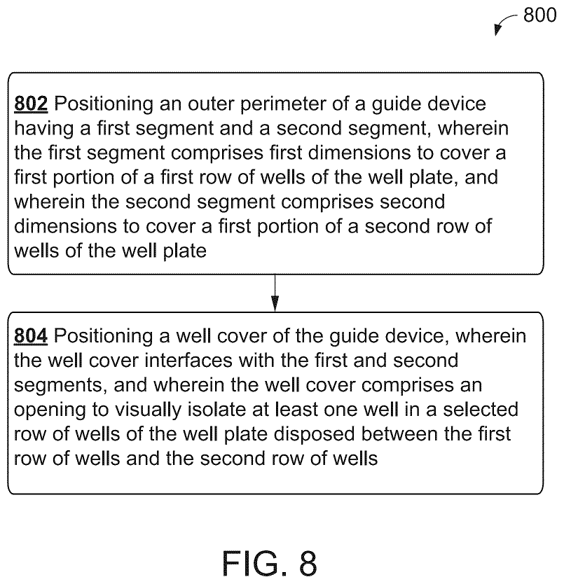

Now referring to FIG. 8, an example method 800 of visually isolating one or more wells of a well plate. The method 800 shown in FIG. 8 presents an example of a method that could be used with the components shown in FIGS. 1-6, for example. Further, devices or systems may be used or configured to perform logical functions presented in FIG. 8. In other examples, components of the devices and/or systems may be arranged to be adapted to, capable of, or suited for performing the functions, such as when operated in a specific manner. In examples, the method 800 may include one or more operations, functions, or actions as illustrated by one or more of blocks 802-806. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 802, in examples, the method 800 for visually isolating one or more wells of a well plate includes positioning an outer perimeter of a guide device having a first segment and a second segment, wherein the first segment comprises first dimensions to cover a first portion of a first row of wells of the well plate, and wherein the second segment comprises second dimensions to cover a first portion of a second row of wells of the well plate. In some examples, the first segment corresponds to an upper segment of the guide device. In some example, the first dimensions of the first segment enable the first segment to fully cover the first row of wells.

At block 804, in examples, the method 800 includes positioning a well cover of the guide device. In examples, the well cover interfaces with the first and second segments, and wherein the well cover comprises an opening to visually isolate at least one well in a selected row of wells of the well plate disposed between the first row of wells and the second row of wells. In some examples, the at least one well in the selected row of wells comprises a single well. In some examples, the well cover does not cover at least one well in the selected row of wells.

In some examples, the well cover is attached to the first segment and the second segment. In some examples, the well cover comprises (i) a first component configured to slide under the first segment and the second segment and (ii) a second component attachable to the first component. The second component may be configured to slide over the first segment and the second segment.

In some examples, the method 800 may include a row window of the guide device that may be defined by the first segment, the second segment, the first side segment, and the second side segment. In some examples, the first side segment corresponds to a left side segment of the guide device, and the second side segment corresponds to a right side segment of the guide device. In some examples, the first side segment is configured to slide along a first edge of the well plate, and the second side segment is configured to slide along a second edge of the well plate.

In some examples, the first segment includes one or more visual indicators to identify the at least one well visually isolated by the opening of the well cover.

In some examples, at least one of the first segment and the second segment comprise at least one of: (i) a plastic material; (ii) a rubber material; or (iii) a metal material. In some examples, the well cover comprises at least one of: (i) a plastic material; (ii) a rubber material; or (iii) a metal material.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

We claim:

1. A guide device for visually isolating one or more wells of a well plate, the guide device comprising:
a first segment comprising first dimensions to cover a first portion of a first row of wells of the well plate;
a second segment comprising second dimensions to cover a first portion of a second row of wells of the well plate; and
a well cover, wherein the well cover interfaces with the first and second segments, and wherein the well cover comprises an opening to visually isolate at least one well in a selected row of wells of the well plate disposed between the first row of wells and the second row of wells.

2. The guide device of claim 1, wherein the at least one well in the selected row of wells comprises a single well.

3. The guide device of claim 1, wherein the well cover does not cover at least one well in the selected row of wells.

4. The guide device of claim 1, further comprising:
a first side segment connecting a first end of the first segment to a first end of the second segment; and
a second side segment connecting a second end of the first segment to a second end of the second segment.

5. The guide device of claim 4, further comprising a row window defined by the first segment, the second segment, the first side segment, and the second side segment.

6. The guide device of claim 4, wherein the first side segment corresponds to a left side segment of the guide device, and wherein the second side segment corresponds to a right side segment of the guide device.

7. The guide device of claim 4, wherein the first side segment is configured to slide along a first edge of the well plate, and wherein the second side segment is configured to slide along a second edge of the well plate.

8. The guide device of claim 1, wherein the well cover is attached to the first segment and the second segment.

9. The guide device of claim 1, wherein the well cover comprises:
a first component configured to slide under the first segment and the second segment; and
a second component attachable to the first component, wherein the second component is configured to slide over the first segment and the second segment.

10. The guide device of claim 1, wherein the first segment includes one or more visual indicators to identify the at least one well visually isolated by the opening of the well cover.

11. The guide device of claim 1, wherein the first segment corresponds to an upper segment of the guide device, and wherein the second segment corresponds to a lower segment of the guide device.

12. The guide device of claim 1, wherein the first dimensions of the first segment enable the first segment to fully cover the first row of wells, and wherein the second dimensions of the second segment enable the second segment to fully cover the second row of wells.

13. The guide device of claim 1, wherein at least one of the first segment and the second segment comprise at least one of: (i) a plastic material; (ii) a rubber material; (iii) a paper material; (iv) a compostable material; or (v) a metal material.

14. The guide device of claim 1, wherein the well cover comprises at least one of: (i) a plastic material; (ii) a rubber material; (iii) a paper material; (iv) a compostable material; or (v) a metal material.

15. A method of fabricating a guide device that is usable to visually isolate one or more wells of a well plate, the method comprising:
fabricating an outer perimeter having a first segment and a second segment, wherein the first segment comprises first dimensions to cover a first portion of a first row of wells of the well plate, and wherein the second segment comprises second dimensions to cover a first portion of a second row of wells of the well plate; and
fabricating a well cover, wherein the well cover interfaces with the first and second segments, and wherein the well cover comprises an opening to visually isolate at least one well in a selected row of wells of the well plate disposed between the first row of wells and the second row of wells.

16. The method of claim 15, wherein the at least one well in the selected row of wells is comprises a single well.

17. The method of claim 15, wherein the well cover does not cover at least one well in the selected row of wells.

18. The method of claim 15, wherein the outer perimeter further comprises:
a first side segment connecting a first end of the first segment to a first end of the second segment; and
a second side segment connecting a second end of the first segment to a second end of the second segment,
wherein a row window is defined by the first segment, the second segment, the first side segment, and the second side segment.

19. A non-transitory computer-readable medium comprising instructions that, when executed by a processor of a computing device, cause the computing device to perform operations comprising:
fabricating an outer perimeter of a guide device having a first segment and a second segment, wherein the first segment comprises first dimensions to cover a first portion of a first row of wells of a well plate, and wherein the second segment comprises second dimensions to cover a first portion of a second row of wells of the well plate; and
fabricating a well cover of the guide device, wherein the well cover interfaces with the first and second segments, and wherein the well cover comprises an opening to visually isolate at least one well in a selected row of wells of the well plate disposed between the first row of wells and the second row of wells.

20. A method of visually isolating one or more wells of a well plate, the method comprising:
positioning an outer perimeter of a guide device, wherein the outer perimeter has a first segment comprising first dimensions to cover a first portion of a first row of wells of the well plate, and wherein the outer perimeter has a second segment comprising second dimensions to cover a first portion of a second row of wells of the well plate; and
positioning a well cover of the guide device, wherein the well cover interfaces with the first and second segments, and wherein the well cover comprises an opening to visually isolate at least one well in a selected row of wells of the well plate disposed between the first row of wells and the second row of wells.

21. A guide device for visually annotating one or more wells of a well plate, the guide device comprising:
an opaque well plate cover having vertical and horizontal dimensions coordinating to
vertical and horizontal dimensions of the well plate and having a plurality of openings in
a vertical and horizontal array configured to line up with the wells in the well plate wherein the well plate cover has one or more visual well indicators on the opaque well plate, in a space between wells, in an illumination zone for a well associated with that visual well indicator.

22. The guide device of claim 1, wherein at least one of the first segment and the second segment comprise at least one of: (i) a plastic material; (ii) a rubber material; (iii) a paper material; (iv) a compostable material; or (v) a metal material.
